(19) United States
(12) Patent Application Publication
(10) Pub. No.: US 2024/0270102 A1
(43) Pub. Date: Aug. 15, 2024

(54) ELECTRIC VEHICLE CHARGING SKID

(71) Applicant: Faith Technologies, Inc., Menasha, WI (US)

(72) Inventors: Craig Nicholas Delahaut, Green Bay, WI (US); Joseph Michael Loose, Menasha, WI (US)

(21) Appl. No.: 18/439,210

(22) Filed: Feb. 12, 2024

Related U.S. Application Data
(60) Provisional application No. 63/445,033, filed on Feb. 13, 2023.

(51) Int. Cl. B60L 53/30

(52) U.S. Cl. CPC B60L 53/30

(57) ABSTRACT

An EV charging skid for mounting at least one EV charger having a first portion of a charger attachment system includes a base frame having a top with a first frame opening and a frame internal space configured to accommodate wiring, the top including a first portion of a plate attachment system, a first adapter plate configured to close the first frame opening, wherein the first adapter plate is generally planar and customized for a specific EV charger model via at least a power aperture for a power connector, an optional ethernet aperture for an ethernet connector, and a second portion of the charger attachment system, wherein the first adapter plate includes a second portion of the plate attachment system, and wherein the plate attachment system is configured to allow the first adapter plate to be attached to the base frame in different azimuthal orientations.

### CROSS-REFERENCE TO RELATED APPLICATIONS

The present application claims priority to the earlier-filed U.S. Provisional Patent Application having Ser. No. 63/445,033, and hereby incorporates the subject matter of the provisional application in its entirety.

### BACKGROUND OF THE INVENTION

Siting of a ground mount electric vehicle (EV) charger typically requires leveling a spot, installing forms, rebar, and conduits, and then pouring concrete to create the slab on which a charger is positioned. This process is expensive, overly permanent, and requires significant worker hours from multiple trades. In addition, adverse weather and other environmental conditions can complicate the installation work because all of the work is done on site and typically outdoors.

### SUMMARY OF THE INVENTION

The present disclosure solves these issues by providing an easy-to-install EV charging skid that can be manufactured under the controlled conditions of a factory and installed with minimal field work. An adapter plate system allows the EV charging skid to accommodate most charger designs and desired orientations without requiring a custom installation on site. The EV charging skid can be shipped fully assembled or in a minimal number of sub-assemblies easily assembled on site. The EV charging skid of the present disclosure minimizes the amount of work hours and trades needed at the site; safety, efficiency, and economy are significantly improved.

The present disclosure describes an EV charging skid for mounting at least one EV charger having a first portion of a charger attachment system, the EV charging skid including a base frame having a top with a first frame opening and a frame internal space configured to accommodate wiring, the top including a first portion of a plate attachment system, a first adapter plate configured to close the first frame opening, wherein the first adapter plate is generally planar and customized for a specific EV charger model via at least a power aperture for a power connector, an optional ethernet aperture for an ethernet connector, and a second portion of the charger attachment system, wherein the first adapter plate includes a second portion of the plate attachment system, and wherein the plate attachment system is configured to allow the first adapter plate to be attached to the base frame in different azimuthal orientations.

The present disclosure also describes a method for providing at a site an EV charging system including an EV charging skid, the method procuring a base frame having a top with a first frame opening and a frame internal space configured to accommodate wiring, the top including a first portion of a plate attachment system; and acquiring a first adapter plate configured to close the first frame opening, wherein the first adapter plate is generally planar and customized for a first specific EV charger model via at least a first adapter plate power aperture for a power connector, an optional first adapter plate ethernet aperture for an ethernet connector, and a second portion of a charger attachment system, wherein the first adapter plate includes a second portion of the plate attachment system, and wherein the plate attachment system is configured to allow the first adapter plate to be attached to the base frame in different azimuthal orientations. The method also includes acquiring a second adapter plate configured to close the first frame opening, wherein the second adapter plate is generally planar and customized for a second specific EV charger model via at least a second adapter plate power aperture for a power connector, an optional second adapter plate ethernet aperture for an ethernet connector, and a second portion of the charger attachment system, wherein the second adapter plate includes a second portion of the plate attachment system, and wherein the plate attachment system is configured to allow the second adapter plate to be attached to the base frame in different azimuthal orientations; and obtaining the first specific EV charger model compatible with the first adapter plate or the second specific EV charger model compatible with the second adapter plate.

The present disclosure further describes an EV charging skid for mounting at least one EV charger having a first portion of a charger attachment system, the EV charging skid including a base frame having a top with a first frame opening, a frame internal space configured to accommodate wiring, a bottom plate, and forklift channels, the top including a first portion of a plate attachment system; and a first adapter plate configured to close the first frame opening, wherein the first adapter plate is generally planar and customized for a first specific EV charger model via at least a first adapter plate power aperture for a power connector, an optional first adapter plate ethernet aperture for an ethernet connector, and a second portion of the charger attachment system, wherein the first adapter plate includes a second portion of the plate attachment system, and wherein the plate attachment system is configured to allow the first adapter plate to be attached to the base frame in different azimuthal orientations. The EV charger also includes, attached to the base frame, any needed electrical hardware selected from disconnects, panels, connectors, power supply line, inverters, converters, regulators, controllers, power modules, and transformers; and the plate attachment system and the charger attachment system each including holes and fasteners.

### BRIEF DESCRIPTION OF DRAWINGS

The foregoing and other features and aspects of the present disclosure and the manner of attaining them will become more apparent, and the disclosure itself will be better understood by reference to the following description, appended claims and accompanying drawings, where:

FIG. 1 representatively illustrates a perspective view of an EV charging skid of the present disclosure with a generic EV charger;

FIG. 2 representatively illustrates a perspective view of a skid of the present disclosure used in the EV charging skid of FIG. 1;

FIG. 3 representatively illustrates a perspective view of a portion of a base frame used in the EV charging skid of FIG. 1;

FIG. 4 representatively illustrates a plan view of one aspect of an adapter plate used in the EV charging skid of FIG. 1; and

FIG. 5 representatively illustrates a perspective view of an alternative aspect of the EV charging skid of FIG. 1 accommodating two chargers.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION OF THE INVENTION

Reference now will be made in detail to various aspects of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one aspect, can be used on another aspect to yield a still further aspect. Thus, it is intended that the present disclosure covers such modifications and variations as come within the scope of the appended claims and their equivalents. Further, for reasons of clarity, repeated identical elements in the figures are not all identified with an element number. As a result, the presence or absence of an element number should not be taken as limiting the disclosure.

The present disclosure provides an easy-to-install EV charging skid that can be manufactured under the controlled conditions of a factory and installed with minimal field work. An adapter plate system allows the EV charging skid to accommodate most charger designs and desired orientations without requiring a custom installation on site. The EV charging skid can be shipped fully assembled or in a minimal number of sub-assemblies easily assembled on site. The EV charging skid of the present disclosure minimizes the amount of work hours and trades needed at the site; safety, efficiency, and economy are significantly improved.

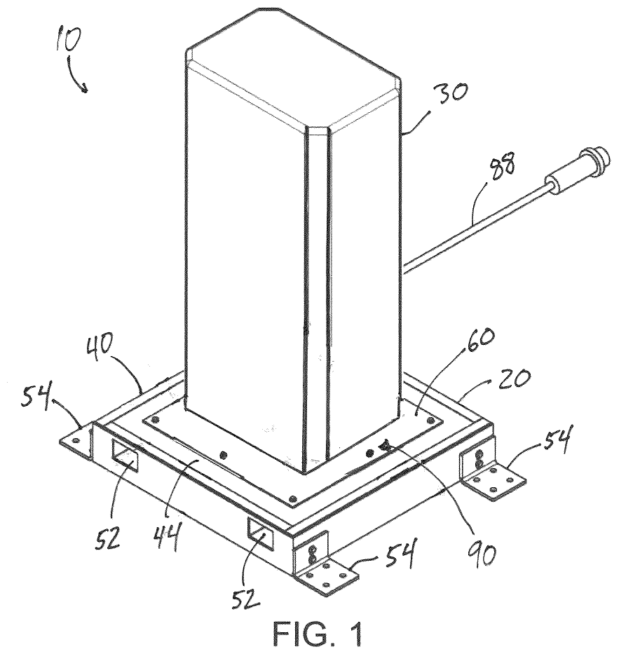

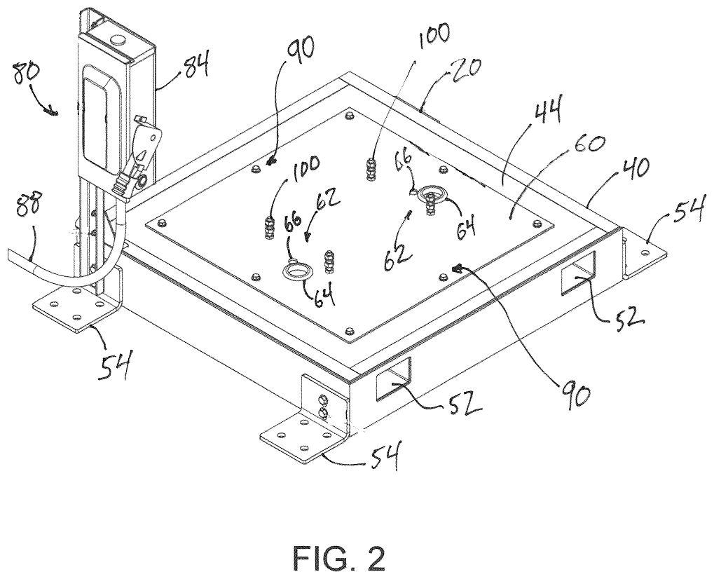

As illustrated in FIGS. 1-3, an EV charging system 10 of the present disclosure includes an EV charging skid 20 configured to be installed at a site. The EV charging skid 20 is also configured to accommodate an EV charger 30 mounted thereon, shown as a generic representation in FIG. 1. The EV charging skid 20 includes as primary components a base frame 40, an adapter plate 60, and any needed ancillary electrical hardware 80 (shown in FIG. 2).

The base frame 40 is a box-like structure constructed from steel, concrete, or any other suitable material. The base frame 40 includes a top 44 with a frame opening 48 therein. The base frame 40 also includes a frame internal space 50 configured to accommodate wiring from the EV charger 30, the ancillary electrical hardware 80, and/or a power source, where wiring can include any wires, conductors, cables, connectors, and the like needed to make electrical, communications, or other connections in the EV charging system 10. The base frame 40 can optionally include forklift channels 52 to allow the EV charging skid 20 to be easily moved.

The base frame 40 can optionally include anchoring brackets 54 attached to the base frame 40 and used to anchor the base frame 40 to the surface on which it is sited. As illustrated in FIGS. 1 and 2, the anchoring brackets 54 are external to the base frame 40. In other aspects of the present disclosure (not shown), the anchoring brackets 54 can be positioned within the frame internal space 50 or the anchoring brackets 54 can be absent with the base frame 40 affixed directly to the surface on which it is sited. The surface can be any suitable and reasonably level surface but need not be a concrete slab. Although each is shown with four anchoring holes, the anchoring brackets 54 can have any number of anchoring holes depending on the desired anchoring system.

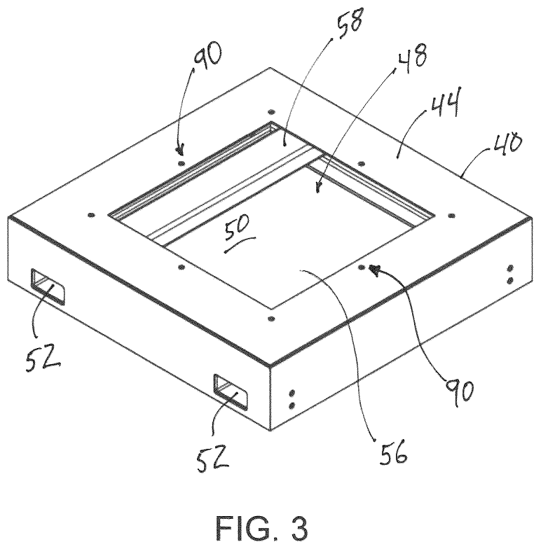

As illustrated in FIG. 3, the base frame 40 can also optionally include a bottom plate 56 to enclose the frame internal space 50 from the bottom of the base frame 40 as well as cross braces 58 as needed for structural strength in the base frame 40. The frame internal space 50 can include conduit, cable trays, and the like (not shown) for control and separation of electrical and other connections present within the frame internal space 50.

The EV charging skid 20 can also include attached to the base frame 40 any needed electrical hardware 80 selected from disconnects, panels, connectors, power supply line, inverters, converters, regulators, controllers, power modules, and transformers. Returning to FIG. 2, the EV charging skid 20 includes a disconnect 84 attached to the base frame 40 and a power supply line 88 attached to the disconnect 84 to supply power through the disconnect 84 and the frame internal space 50 to the EV charger 30. The EV charging skid 20 can include any other electrical hardware 80 needed to control and supply the appropriate AC or DC voltage required by the EV charger 30.

The top 44 of the base frame 40 includes a portion of a plate attachment system 90 configured to allow the adapter plate 60 to be temporarily or permanently affixed to the base frame 40, where the adapter plate 60 includes another portion of the plate attachment system 90. The plate attachment system 90 can be holes and fasteners such as bolts, nuts, screws, and the like. The plate attachment system 90 can also be welds, adhesive components, or any other suitable attachment means.

The adapter plate 60 is a generally planar plate constructed from steel or any other suitable material and configured to close the frame opening 48 when the adapter plate 60 is affixed to the base frame 40. An EV charger 30 is affixed to the adapter plate 60 using a charger attachment system 100, a portion of which can be carried by the adapter plate 60 with another portion carried by the EV charger 30. The charger attachment system 100 can be holes and fasteners such as bolts, nuts, screws, and the like. The charger attachment system 100 can also be welds, adhesive components, or any other suitable attachment means.

The adapter plate 60 includes apertures 62 sized and positioned to accommodate wiring needed for the EV charger 30. Apertures 62 in the adapter plate 60 can include a power connector aperture 64, an ethernet connector aperture 66, and any additional desired apertures. The adapter plate 60 can be customized to accommodate a specific EV charger model 30 by sizing and positioning the apertures 62 and charger attachment system 100 to match those required by the EV charger 30. In this manner the same base frame 40 can be used with any EV charger 30 for which a customized adapter plate 60 can be configured. The base frame 40 does not need to be customized for an EV charger 30 because the adapter plate 60 performs that function.

This configuration not only allows for the use of different EV charger models 30 with the same base frame 40, it also allows an installed EV charger 30 to be replaced with a different model on site without re-installing a different base frame 40. The old EV charger 30 with its customized adapter plate 60 is simply replaced with a different EV charger 30 with its own customized adapter plate 60 without disturbing the installed base frame 40.

In a similar manner, the plate attachment system 90 can be configured to allow an adapter plate 60 to be attached to the base frame 40 in any azimuthal orientation, where the azimuthal orientation is the position of the adapter plate 60 relative to the base frame 40 as it rotates in a horizontal plane about an imaginary vertical central axis. A symmetric square adapter plate 60 such as that illustrated can be attached to the base frame 40 in at least four azimuthal orientations. With an EV charger 30 attached to an adapter plate 60, this means that in the illustrated aspect the EV charger 30 can be installed facing any orthogonal direction based on the azimuthal orientation of the adapter plate 60.

In an alternative aspect (not shown), the base frame 40 can include the internal support framework and frame opening 48 sizing necessary to allow an adapter plate 60 to be attached to the base frame 40 flush with the top 44 of the base frame 40 or recessed from the top 44 of the base frame 40.

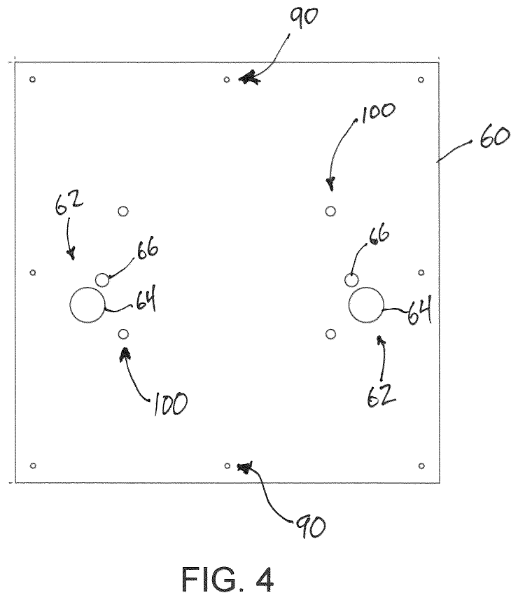

In other aspects of the present disclosure (not shown), the adapter plate 60 need not be square as illustrated in FIGS. 1, 2, and 4. For example, an adapter plate 60 in the shape of an equilateral triangle would yield three azimuthal orientations of the adapter plate 60 and thus the EV charger 30. In a further example, a circular adapter plate 60 could yield a nearly infinite number of azimuthal orientations of the adapter plate 60 and thus the EV charger 30 depending on the features of the plate attachment system.

The EV charging skid 20 of the present disclosure can also include protective bollards (not shown) attached to the base frame 40 for the protection of any components associated with the EV charging skid 20.

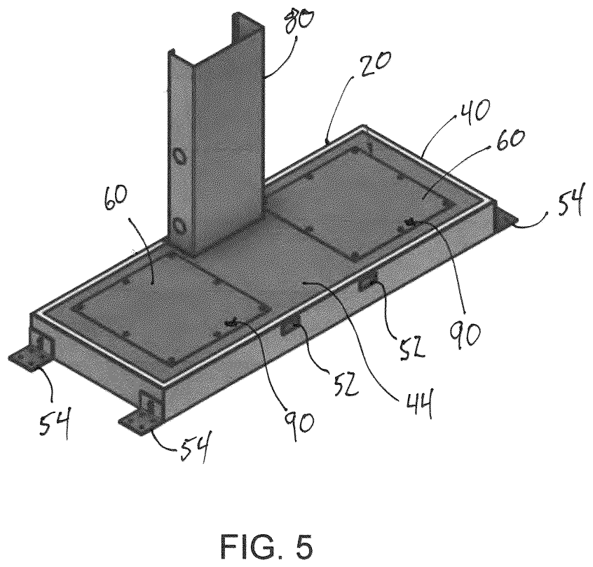

Turning to FIG. 5, an EV charging skid 20 can be configured to accommodate two or more EV chargers (not shown for clarity). In a specific aspect, a base frame 40 can be configured such that its top 44 includes two adapter plates 60 closing two frame openings (not shown) in the top 44 of the base frame 40. The adapter plates 60 can still be customized for specific EV charger models via power connector, ethernet, and any other needed apertures. Apertures and charger attachment systems are not shown for clarity. The two adapter plates 60 need not be identical and can be customized for different models of EV chargers. The base frame 40, adapter plates 60, and EV charger can have plate attachment systems 90 and charger attachment systems as appropriate and as described above. The two adapter plates 60 need not be the same shape as long as their associated plate attachment systems 90 are compatible with those of their intended positions on the base frame 40. Both adapter plates 60 can be configured to allow the adapter plates 60 to be attached to the base frame 40 in different azimuthal orientations.

The azimuthal orientation of one adapter plate 60 can be the same or different from the azimuthal orientation of another adapter plate 60. Keeping in mind that each adapter plate 60 can be customized for different specific EV charger models, each of two identical or different EV charger models can be positioned on the EV charging skid 20 independently of the azimuthal orientation of the other EV charger as desired for a particular installation.

In alternative aspects of the present disclosure, the EV charging skid 20 can be configured to accommodate one, two, three, four, or more EV chargers (not shown). Each EV charger can include one or more charging points, and each EV charger can be identical to or a model different from one or more of the other EV chargers. If the EV charging system 10 includes three or more EV chargers, the EV chargers can be disposed in a linear array, a square array, or in any other suitable arrangement. The EV charging system 10 of the present disclosure flexibly accommodates any number of EV chargers of any identical or differing model and in any azimuthal orientations.

The flexibility of this EV charging system 10 allows for different levels of offsite versus onsite construction. The three primary components of the EV charging system 10 are the base frame 40, the adapter plate(s) 60, and the EV charger(s) 30 and are typically constructed or acquired offsite. In one aspect, these three components can be shipped to a site and assembled into an EV charging skid 20 onsite by attaching the EV charger(s) 30 to the adapter plate(s) 60 and the adapter plate(s) 60 to the base frame 40.

In another aspect, an adapter plate 60 is attached to its associated EV charger 30 offsite to form a charger and plate combination, and the combination and a base frame 40 are shipped to a site and assembled into an EV charging skid 20 onsite by attaching the combination to the base frame 40.

In an alternative aspect, the adapter plate 60 is attached to its associated specific EV charger model 30 and to the base frame 40 into an EV charging skid 20 offsite and then shipped to a site as a complete unit ready for installation.

While the disclosure has been described in detail with respect to specific aspects thereof, it will be appreciated that those skilled in the art, upon attaining understanding of the foregoing will readily appreciate alterations to, variations of, and equivalents to these aspects. Accordingly, the scope of the present disclosure should be assessed as that of the appended claims and any equivalents thereto. Additionally, all combinations and/or sub-combinations of the disclosed aspects, ranges, examples, and alternatives are also contemplated.

1. An EV charging skid for mounting at least one EV charger having a first portion of a charger attachment system, the EV charging skid comprising:
a base frame having a top with a first frame opening and a frame internal space configured to accommodate wiring, the top including a first portion of a plate attachment system; and
a first adapter plate configured to close the first frame opening, wherein the first adapter plate is generally planar and customized for a specific EV charger model via at least a power aperture for a power connector, an optional ethernet aperture for an ethernet connector, and a second portion of the charger attachment system, wherein the first adapter plate includes a second portion of the plate attachment system, and wherein the plate attachment system is configured to allow the first adapter plate to be attached to the base frame in different azimuthal orientations.

2. The EV charging skid of claim 1, wherein the base frame includes forklift channels.

3. The EV charging skid of claim 1, the top further including a second frame opening and a second adapter plate configured to close the second frame opening, wherein the second adapter plate is generally planar and customized for a specific EV charger model via at least a power aperture for a power connector, an optional ethernet aperture for an ethernet connector, and a second portion of the charger attachment system, wherein the second adapter plate includes a second portion of the plate attachment system, and wherein the plate attachment system is configured to allow the second adapter plate to be attached to the base frame in different azimuthal orientations.

4. The EV charging skid of claim 3, wherein the azimuthal orientation of the first adapter plate is different from the azimuthal orientation of the second adapter plate.

5. The EV charging skid of claim 3, wherein the first and second adapter plates are customized for different specific EV charger models.

6. The EV charging skid of claim 1, further comprising anchoring brackets attached to the base frame.

7. The EV charging skid of claim 6, wherein the anchoring brackets are external to the base frame.

8. The EV charging skid of claim 1, further comprising attached to the base frame any needed electrical hardware selected from disconnects, panels, connectors, power supply line, inverters, converters, regulators, controllers, power modules, and transformers.

9. The EV charging skid of claim 1, the base frame further comprising a bottom plate.

10. The EV charging skid of claim 1, the plate attachment system including holes and fasteners.

11. The EV charging skid of claim 1, wherein the base frame and first adapter plate are substantially steel.

12. A method for providing at a site an EV charging system including an EV charging skid, the method comprising:
procuring a base frame having a top with a first frame opening and a frame internal space configured to accommodate wiring, the top including a first portion of a plate attachment system;
acquiring a first adapter plate configured to close the first frame opening, wherein the first adapter plate is generally planar and customized for a first specific EV charger model via at least a first adapter plate power aperture for a power connector, an optional first adapter plate ethernet aperture for an ethernet connector, and a second portion of a charger attachment system, wherein the first adapter plate includes a second portion of the plate attachment system, and wherein the plate attachment system is configured to allow the first adapter plate to be attached to the base frame in different azimuthal orientations;
acquiring a second adapter plate configured to close the first frame opening, wherein the second adapter plate is generally planar and customized for a second specific EV charger model via at least a second adapter plate power aperture for a power connector, an optional second adapter plate ethernet aperture for an ethernet connector, and a second portion of the charger attachment system, wherein the second adapter plate includes a second portion of the plate attachment system, and wherein the plate attachment system is configured to allow the second adapter plate to be attached to the base frame in different azimuthal orientations; and
obtaining the first specific EV charger model compatible with the first adapter plate or the second specific EV charger model compatible with the second adapter plate.

13. The method of claim 12, wherein obtaining includes obtaining the first specific EV charger model compatible with the first adapter plate, attaching the first adapter plate to the specific EV charger model away from the site to form a charger and plate combination, then shipping the charger and plate combination to the site.

14. The method of claim 13, further comprising subsequently attaching the first adapter plate to the base frame at the site.

15. The method of claim 12, wherein obtaining includes obtaining the first specific EV charger model compatible with the first adapter plate, shipping the first specific EV charger model, the first adapter plate, and the base frame to the site, then attaching the first adapter plate to the first specific EV charger model and the first adapter plate to the base frame at the site.

16. The method of claim 12, wherein obtaining includes obtaining a first specific EV charger model compatible with the first adapter plate, attaching the first adapter plate to the first specific EV charger model and the first adapter plate to the base frame away from the site to form a charger plate base frame combination, and subsequently shipping the charger plate base frame combination to the site.

17. An EV charging skid for mounting at least one EV charger having a first portion of a charger attachment system, the EV charging skid comprising:
a base frame having a top with a first frame opening, a frame internal space configured to accommodate wiring, a bottom plate, and forklift channels, the top including a first portion of a plate attachment system;
a first adapter plate configured to close the first frame opening, wherein the first adapter plate is generally planar and customized for a first specific EV charger model via at least a first adapter plate power aperture for a power connector, an optional first adapter plate ethernet aperture for an ethernet connector, and a second portion of the charger attachment system, wherein the first adapter plate includes a second portion of the plate attachment system, and wherein the plate attachment system is configured to allow the first adapter plate to be attached to the base frame in different azimuthal orientations;
attached to the base frame any needed electrical hardware selected from disconnects, panels, connectors, power supply line, inverters, converters, regulators, controllers, power modules, and transformers; and
the plate attachment system and the charger attachment system each including holes and fasteners.

18. The EV charging skid of claim 17, the top further including a second frame opening and a second adapter plate configured to close the second frame opening, wherein the second adapter plate is generally planar and customized for a second specific EV charger model via at least a second adapter plate power aperture for a power connector, an optional second adapter plate ethernet aperture for an ethernet connector, and a second portion of the charger attachment system, wherein the second adapter plate includes a second portion of the plate attachment system, and wherein the plate attachment system is configured to allow the second adapter plate to be attached to the base frame in different azimuthal orientations.

19. The EV charging skid of claim 18, wherein the azimuthal orientation of the first adapter plate is different from the azimuthal orientation of the second adapter plate.

20. The EV charging skid of claim 18, wherein the first and second adapter plates are customized for different specific EV charger models.
